(19) United States
(12) Patent Application Publication
(10) Pub. No.: US 2013/0042134 A1
(43) Pub. Date: Feb. 14, 2013

(54) SYSTEM FOR MEASURING PHASE CURRENT

(71) Applicants: Lan-Yi FENG, Shenzhen City (CN); Ying-Bin FU, Shenzhen City (CN)

(72) Inventors: Lan-Yi FENG, Shenzhen City (CN); Ying-Bin FU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/313,177

(22) Filed: Dec. 7, 2011

(30) Foreign Application Priority Data
Aug. 9, 2011 (CN) 201110227017.7

(51) Int. Cl. G06F 1/26

(52) U.S. Cl. 713/340

(57) ABSTRACT

A system for measuring phase current includes a power control module, a processor, and a display device. The power control module is connected to the CPU power source to store values of phase current output by the CPU power source. The processor is connected to the power control module to obtain the values of the phase currents stored in the power control module, and calculates a difference among the values of the phase currents. The display device is connected to the processor to display the values of the phase currents and the calculated difference.

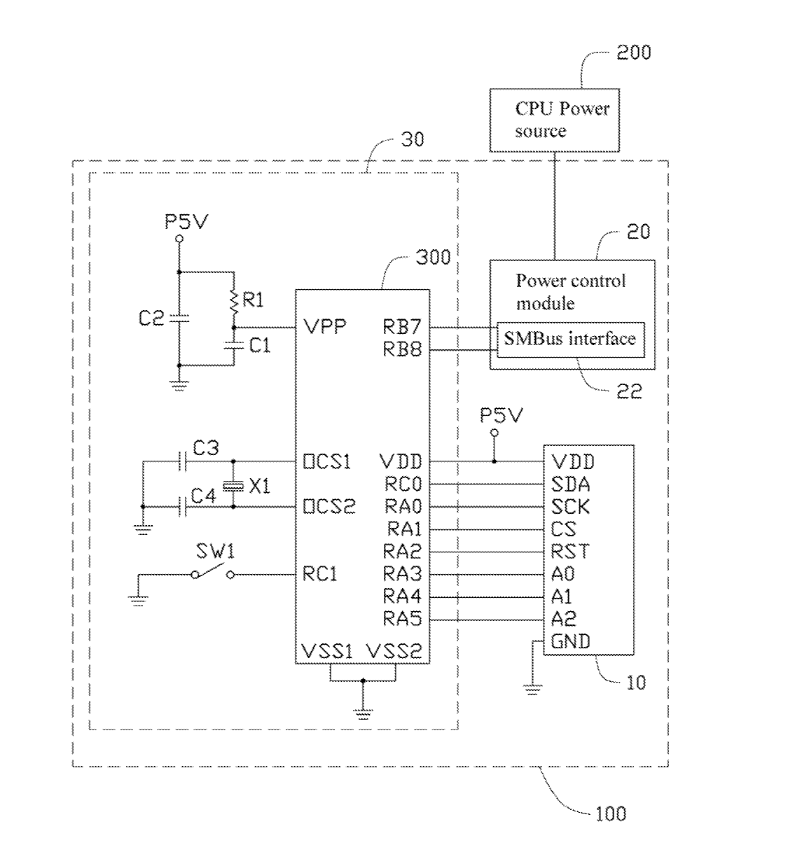

### Technical Field

The present disclosure relates to systems, and particularly, to a system for measuring phase current.

### Description of Related Art

A method adopted to test phase current output by a central processing unit (CPU) power source uses an inductor connected to an output terminal of the CPU power source, and a resistor and a capacitor connected between two terminals of the inductor in series. A voltage measuring device is connected to the two terminals of the capacitor to measure a voltage of the capacitor. A single phase current value of the CPU power source can be calculated according to the measured voltage value and resistance of the inductor. However, the voltage value measured by the voltage measuring device is often inaccuracy, so it may lead to an inaccurate test result.

### BRIEF DESCRIPTION OF THE DRAWING

Many aspects of the present embodiments can be better understood with reference to the following drawings. The components in the drawing are not necessarily drawn to scale, the emphasis instead being placed upon clearly illustrating the principles of the present disclosure. Moreover, in the drawings, all the views are schematic, and like reference numerals designate corresponding parts throughout the several views.

The figure is a circuit diagram of an exemplary embodiment of a system for measuring phase current connected to a central processing unit power source.

### DETAILED DESCRIPTION

The disclosure, including the accompanying drawings in which like references indicate similar elements, is illustrated by way of example and not by way of limitation. It should be noted that references to “an” or “one” embodiment in this disclosure are not necessarily to the same embodiment, and such references mean at least one.

Referring to the figure, an embodiment of a system 100 for measuring phase current includes a power control module 20, a display device 10, and a control circuit 30. The power control module 20 is connected to the CPU power source 200 to store values of the phase current output by the CPU power source 200. The control circuit 30 is connected to the power control module 20 to obtain the values of the phase currents output by the CPU power source 200. The control circuit 30 is also connected to the display device 10 to control the display device 10 to display the values of the phase currents.

In the embodiment, the power control module 20 is a power control chip supporting VR12 platform processors. According to work principle of the power control module 20, a system management bus (SMBus) interface 22 is mounted in the power control module 20. Therefore, the control circuit 30 can directly obtain the values of the phase current values through the SMBus interface 22.

The control circuit 30 includes a processor 300, a resistor R1, four capacitors C1-C4, a crystal oscillator X1, and a switch SW1. The processor 300 includes two voltage pins VDD and VPP, a reset pin RC1, two clock pins OCS1 and OCS2, two ground pins VSS1 and VSS2, and data pins RA0-RAS, RB7, RB8, and RC0. The voltage pin VDD is connected to a power source P5V, and a power pin VDD of the display device 10. The resistor R1 and the capacitor C1 are connected in series between the power source P5V and ground. The capacitor C2 is connected between the power source P5V and ground. The voltage pin VPP is connected to a node between the resistor R1 and the capacitor C1. The crystal oscillator X1 is connected between the clock pins OSC1 and OSC2. The clock pin OSC1 is grounded through the capacitor C3. The clock pin OSC2 is grounded through the capacitor C4. The switch SW1 is connected between the reset pin RC1 and ground. The ground pins VSS1 and VSS2 are both grounded. The data pins RB7 and RB8 are connected to the SMBus interface 22 of the power control module 20. The data pins RA1-RA5 are respectively connected to pins CS, RST, A0, A1, and A2 of the display device 10. The data pins RA0 and RC0 are respectively connected to pins SCK and SDA of the display device 10.

In use, the switch SW1 is turned on. The reset pin RC1 of the processor 300 receives a logic 0 low level signal. The processor 300 obtains the values of the phases currents output by the CPU power source 200 through the data pins RB7 and RB8 of the processor 300 and the SMBus interface 22, and calculates a difference among the values of the phase currents. For example, the CPU power source 200 has four phases. Therefore, the processor 300 obtains the values of the four phase currents, which are respectively I1, I2, I3, and I4, wherein I1 is the largest. The difference is equal to the formula [I1−(I1+I2+I3+I4)/4]/[(I1+I2+I3+I4)/4]. The processor 300 controls the display device 10 to display the values of the phase currents and the difference through the data pins RA0-RA5, and RC0.

Although numerous characteristics and advantages of the embodiments have been set forth in the foregoing description, together with details of the structure and function of the embodiments, the disclosure is illustrative only, and changes may be made in detail, especially in the matters of shape, size, and arrangement of parts within the principles of the embodiments to the full extent indicated by the broad general meaning of the terms in which the appended claims are expressed.

What is claimed is:

1. A system for measuring phase current comprising:
a power control module connected to the CPU power source to store values of phase current output by the CPU power source;
a processor connected to the power control module to obtain the values of the phase currents stored in the power control module, and to calculate a difference among the values of the phase currents; and
a display device connected to the processor to display the values of the phase currents and the calculated difference.

2. The system of claim 1, further comprising a switch connected to the processor, wherein when the switch is turned on, the processor is turned on to obtain the values of the phase currents from the power control module.

3. The system of claim 1, further comprising a resistor, a first capacitor, and a second capacitor, wherein the first capacitor and the resistor are connected between a power source and ground in series, the second capacitor is connected between the power source and ground, a node between the first capacitor and the resistor is connected to the processor.
